(19) United States
(12) Patent Application Publication
(10) Pub. No.: US 2024/0381062 A1
(43) Pub. Date: Nov. 14, 2024

(54) SYSTEMS AND METHODS FOR COMPREHENSIVE INTEGRATED INCIDENT RESPONSE

(71) Applicant: AEGIX GLOBAL, LLC, Salt Lake City, UT (US)

(72) Inventors: Chet D. Linton, Salt Lake City, UT (US); David L. Benson, Salt Lake City, UT (US); Michael D. Huff, Salt Lake City, UT (US)

(21) Appl. No.: 18/662,457

(22) Filed: May 13, 2024

Related U.S. Application Data
(60) Provisional application No. 63/502,023, filed on May 12, 2023.

(51) Int. Cl. H04W 4/90; H04W 4/14; H04W 64/00

(52) U.S. Cl. CPC H04W 4/90; H04W 4/14; H04W 64/00

(57) ABSTRACT

A computer network system for gathering and disseminating information regarding an incident can include a processor electrically coupled to a memory component storing executable instructions that, when executed by the processor, cause the system to receive a dataset including the information regarding the incident at a central storage. Additionally, the computer network system can enable a responder to the incident to distribute the information from the central storage, including distributing a first information subset of the dataset and a second information subset of the dataset selected by the responder. Furthermore, the computer network system can send the first information subset to a first person in physical proximity to the incident and send the second information subset of the dataset to a second person physically distanced from the incident. In some examples, the second information subset includes at least a portion of the information not included in the first information subset.

### CROSS-REFERENCE TO RELATED APPLICATION(S)

This application claims priority to and the benefit of U.S. Provisional Application No. 63/502,023, titled “SYSTEMS AND METHODS FOR COMPREHENSIVE INTEGRATED INCIDENT RESPONSE,” filed on May 12, 2023 and which is incorporated herein in its entirety by reference.

### FIELD

The described embodiments relate generally to incident management and facilitating direct communication to law enforcement and first responders in emergency situations.

### BACKGROUND

Incidents and emergencies are often left to federal, state, and local first responder agencies to resolve. Unfortunately, the general public and those impacted by some type of emergency or critical incident are often left in the dark. First responders, likewise, are sent to buildings, structures and events with little data and information that can help them resolve the incident quickly. In other situations, first responders receive uncorrelated information difficult to effectively use. This lack of sufficient data can lead to responders operating in what is often referred to as “the big black hole.”

Many current dispatch systems struggle to centralize emergency and/or critical information. Much of the information first responders and other agencies have access to is gained through various sources, such as panicked 911 calls, various decentralized radio transmissions between agencies or individual responders, and so forth. Additionally, information learned about an emergency situation through interactions with witnesses and bystanders may not be widespread among first responders. Another problem facing first responders is communicating with and directing individuals subject to emergency situations, as well as those in surrounding areas.

Consequently, what is needed is a comprehensive solution for an integrated incident response that can centralize critical information and enable first responders to effectively communicate with individuals subject to emergency situations to reduce response times and improve outcomes for victims and others involved in emergency situations.

### SUMMARY

In accordance with one or more examples of the present disclosure, a computer network system for gathering and disseminating information regarding an incident can include a processor electrically coupled to a memory component storing executable instructions that, when executed by the processor, cause the system to receive a dataset including the information regarding the incident at a central storage. Additionally, the computer network system can enable a responder to the incident to distribute the information from the central storage, including distributing a first information subset of the dataset and a second information subset of the dataset selected by the responder. Furthermore, the computer network system can send the first information subset to a first person in physical proximity to the incident and send the second information subset of the dataset to a second person physically distanced from the incident. In some examples, the second information subset includes at least a portion of the information not included in the first information subset.

In some examples, the responder is a first responder, and the transmitted communication can include a communication from the first responder to a second responder to the incident. In one or more examples, the system can also include where the information includes at least one of a type of the incident, a location of the incident, a building structure type associated with the incident, or a map overlay of the incident. In some examples, the system can be configured to distribute the first information dataset and the second information dataset via a mobile software application.

In one or more examples of the present disclosure, a computing apparatus includes a processor. In some examples, the computing apparatus can also include a memory for storing instructions that, when executed by the processor, can configure the apparatus to wirelessly connect to a security network system located at an area of an incident. In some examples, the processor can be configured to detect the incident via information gathered by components of the security network system.

In some examples, the processor can further be configured to receive a dataset from the security network system, where the dataset can include the gathered information regarding the incident. In at least one example, the processor of the computing apparatus can enable an incident responder to distribute the information from the dataset, where the information includes a first subset of the dataset selected by the responder and a second subset of the dataset. In some examples, the processor can send the first subset to a first group of persons located at the area. Additionally, the processor can send the second subset to a second group of persons physically distanced from the area, where the first subset includes at least a portion of the information not included in the second subset.

In some examples, the components of the security network system can include at least one of a video camera, a security door, a security system, a motion sensor, a first responder dispatch system, or an intercom system. In at least one example, the information can be dynamically updated via a data stream to the processor. In some examples, the instructions can include a facial recognition algorithm, where the processor can be configured to detect the incident via the facial recognition algorithm using algorithm inputs including the information from the components of the security network system.

In some examples, the instructions can include an object recognition algorithm, where the processor can be configured to detect the incident via object recognition algorithm using algorithm inputs including the information from the components of the security network system. In some examples, the information distributed to first group of persons and the second group of persons can be viewable via a mobile software application. Other technical features may be readily apparent to one skilled in the art from the following figures, descriptions, and claims.

In some examples, a non-transitory computer-readable storage medium can include instructions that, when executed by a computer, cause the computer to receive a report from a witness of an incident. In some examples, the computer can notify a responder of the report and enable the responder to distribute information from the report. In some examples, the information can include a portion of the report selected by the responder. In one or more examples, the computer can send the portion of the report to an incident group, where the incident group can include an individual who did not witness the incident.

In some examples, the responder can include an individual having authority over a premises of the incident. In at least one example, the report can include at least one of an alert, a notification, or a tip corresponding to the incident. Other technical features may be readily apparent to one skilled in the art from the following figures, descriptions, and claims.

In some examples, the system can enable the first and second responders to participate in inter-group communications via an instant message chat function. In some examples, the responder can be identified based on at least the type of the incident. In at least one example, the dataset can include status and locational information of the first person and the second person. In some examples, a mobile software application can be configured to share the status and locational information to the responder. Additionally, the system can provide reunification instructions, where the reunification instructions can include instructions directing the second person how to reunify with the first person.

In some examples, the first information subset includes instructions from the responder that can include at least one of an evacuation route, a movement instruction, or an incident update. In some examples, the second information subset can include instructions from the responder that can include at least one of an alert, an incident update, location data, or reunification instructions. Other technical features can be readily apparent to one skilled in the art from the following figures, descriptions, and claims.

The disclosure will be readily understood by the following detailed description in conjunction with the accompanying drawings, wherein like reference numerals designate like structural elements, and in which:

### BRIEF DESCRIPTION OF THE DRAWINGS

FIG. 1 illustrates a diagram of a computer network system, according to one or more examples of the present disclosure;

FIG. 2 illustrates a diagram of the dissemination of information, according to one or more examples of the present disclosure;

FIG. 3 illustrates a diagram of distributing and gathering information, according to one or more examples of the present disclosure;

FIG. 4 illustrates a diagram of a security network system, according to one or more examples of the present disclosure;

FIG. 5 illustrates an example of a map of an incident area, according to one or more examples of the present disclosure; and

FIG. 6 illustrates a diagram of a computing apparatus connected to a network, according to one or more examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to incident management and facilitating direct communication to law enforcement and first responders in emergency situations. In at least one example, the present disclosure includes a computer network system for gathering and disseminating information regarding an incident. In some examples, the computer network system can include a processor electrically coupled to a memory component storing executable instructions that. When executed by the processor, the instructions can cause the computer network system to receive a dataset including the information regarding the incident and enable a responder to the incident to distribute the information.

Many current dispatch systems struggle to centralize emergency and/or critical information. Incidents and emergencies are often left to federal, state, and local first responder agencies to resolve. Much of the information these agencies have access to is gained through various sources. Unfortunately, the general public and those impacted by some type of emergency or critical incident are often left in the dark. First responders, likewise, are sent to buildings, structures and events with uncorrelated information difficult to effectively use.

Additionally, new information about an emergency situation may not be widespread among first responders. Furthermore, communicating with and directing individuals subject to emergency situations, as well as those in surrounding areas can prove to be difficult for first responders and related agencies. The invention disclosed herein provides a system for an integrated incident response that can centralize critical information and enable first responders to effectively communicate with individuals subject to emergency situations.

According to one or more examples of the present disclosure, a computer network system can receive a dataset of incident information, where the dataset can be a combination of data from various incident sources. In some examples, the dataset can include tips and dispatch calls, such as 911 calls. In at least one example, the dataset can include incident-specific information. In some examples, the incident-specific information can include at least one of the type of incident, location of the incident, a building structure type associated with the incident, or a map overlay of the incident. This can provide the responder with additional information, thus helping to reduce the amount of confusion inherit in responding to an emergency situation.

In some examples, the computer network system can enable a responder to distribute a first information subset of the dataset and distribute a second information subset of the dataset. In at least one example, the computer network system can send the first information subset to a first person in physical proximity to the incident and send the second information subset of the dataset to a second person physically distanced from the incident. In some examples, the second information subset can include at least a portion of the information not included in the first information subset. This can enable the responder to select what information to send to individuals subject to an emergency situation.

In at least one example, the responder can send instructions to the first person and the second person via the first and second information subsets. In some examples, these instructions can include guidance evacuation routes, movement instructions, and reunification instructions. This can enable the responder to better control a critical situation. Additionally, the responder can receive location and status data pertaining to the first person and the second person during an incident. This can enable the responder to tailor instructions or response strategy to the individual situations of the people in an emergency situation.

In some examples, a computing apparatus of the computer network system can wirelessly connect to a security network. In some instances, the location of the incident can be a building, campus, or other location with its own security network. In at least one example, the computing apparatus can connect to the various components of this local security network. For example, the computing apparatus can be configured to receive data streams from video cameras, motion sensors, security doors, and similar devices/systems. This can enable the responder to the incident to access additional data about an emergency situation, thus further decreasing response times.

In some examples, the computing apparatus can detect an incident via the components of a local security network. In at least one example, the computing apparatus can use facial detection and object detection to detect emergency situations. For example, the computing apparatus can analyze a data stream of a video camera to detect a gun, bomb, or other weapon that could cause a critical incident. This can provide an early alert to first responders, which can help reduce response times.

In one or more examples of the present disclosure, the responder can access all of the information in the dataset. In addition to accessing the information in the dataset, the responder can access previous communications with incident sources and communications between responders. This can enable a responder to stay up to date with the incident and with what actions other responders are taking. This can also help reduce repetitive communications between responders when responding to an emergency situation.

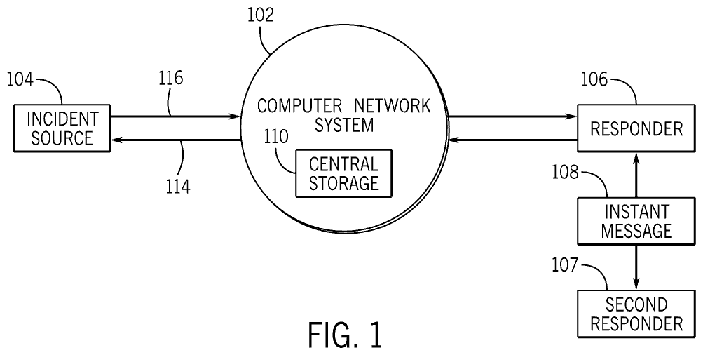

These and other embodiments are discussed below with reference to FIGS. 1-6. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a diagram of interactions with a computer network system 102, in accordance with one or more examples of the present disclosure. In some examples, the computer network system 102 can be used for gathering and disseminating information regarding an incident. Examples of the incident can include situations such as bomb threats and mass shootings to natural disasters like fires and hurricanes.

In at least one example, the computer network system 102 can include a processor electrically coupled to a memory components storing executable instructions that, when executed by the processor, cause the computer network system 102 to receive information regarding the incident from an incident source 104. In some examples, the incident source 104 can include a variety of sources. In some examples, the incident source 104 can include emergency dispatch calls, social media updates, telephone calls, or other data sources. In one or more examples, the incident source 104 can further include a dataset 116, where the dataset 116 includes information regarding the incident from the incident source 104. In at least one example, the computer network system 102 can be configured to receive the dataset 116. Further examples of the dataset 116 will be disclosed throughout the present disclosure.

In one or more examples, the computer network system 102 can receive the dataset 116 at a central storage 110. In some examples, the central storage 110 can be a memory system of the computer network system 102. In at least one example, the central storage 110 can be a non-transitory computer-readable storage medium. In some examples, the central storage 110 can include instructions that, when executed by a computer, cause the computer to perform the actions of the computer network system 102 described in the present disclosure.

In some examples, from the central storage 110, the dataset 116 can be provided to a responder 106. In accordance with the present disclosure, the responder 106 can be a single individual or a group of responders. In at least one example, the responder 106 can be law enforcement, firefighters, emergency medical services, or other kinds of first-responders. In some examples, the responder 106 can also be staff of different premises and/or organizations. For example, the responder 106 can be a school administrator in the event the incident occurs at a school. Receiving the dataset 116 can enable the responder 106 to gather information pertaining to the incident. This can help streamline information received about the incident and speed up the response time of the responder 106.

In some examples, the responder 106 is a first responder. In at least one example, the first responder may desire to communicate with a second responder 107 regarding the incident. In at least one example, the computer network system 102 can enable the responder 106 and the second responder 107 to participate in inter-group communications via an instant message 108 chat function. In this example, the instant message 108 chat function can be a closed chat for the use of the responder 106 to the second responder 107. This function can help the responder 106 communicate to colleagues or other emergency personnel in a streamlined way. For example, the responder 106 can alert a colleague of information contained within the dataset 116 without switching to a radio or other form of communication. This function can further decrease response times in regard to an incident.

In some examples, the communications used with the instant message 108 chat function can be archived in the central storage 110 of the computer network system 102. In at least one example, this can enable other responders or emergency personnel to access and review previous communications. In some examples, this can reduce the amount of repetitive communication and confusion between the responder 106 and other individuals, thus further decreasing response times.

In one or more examples of the present disclosure, the responder 106 can communicate back to the incident source 104 via a return communication 114. In some examples, the return communication 114 can be a communication sent through the computer network system 102. In some examples, the communications between the incident source 104 and the responder 106, such as the return communication 114, can be archived in the central storage 110 of the computer network system 102.

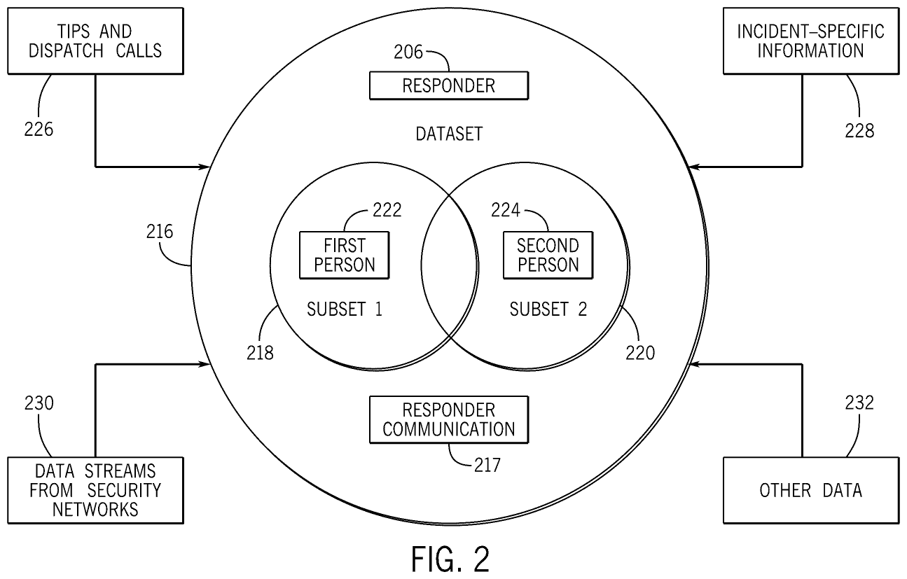

In some examples, the dataset 116 can include a communication transmitted by the responder regarding the incident after the dataset 116 is received, as shown in FIG. 2 below as a responder communication 217. In some examples, the responder communication 217 can include a communication from the first responder 106 to the second responder 107 to the incident. This can enable communications between responders or other emergency personnel to be made available to additional people. Additionally, the responder communication 217 can include the archived history of the return communication 114 and other communications between the responder 106 and the incident source 104. During an incident, this can help distribute relevant information, which can further help reduce repetitive information and decrease response times.

In at least one example, the computer network system 102 can receive the dataset 116, where the dataset 116 can include a report from a witness of the incident. In some examples, the report included in the dataset 116 can include at least one of an alert, a notification, or a tip corresponding to the incident.

In some examples, the incident source 104 can be the witness of the incident. In some examples, the computer network system 102 can notify the responder 106 of the report. In at least one example, this can enable the responder 106 to distribute information about the incident, where the information includes a portion of the report selected by the responder. In some examples, the computer network system 102 can send the portion of the report to an incident group. In at least one example, the incident group can include an individual who did not witness the incident. In some examples, the responder 106 can include an individual having authority over a premise of the incident. For example, in the case where the incident occurs at a school, the responder 106 can include a school administrator or principal, or if the incident occurs at an even center, the responder 106 can include an event security guard or usher-. This can enable the computer network system 102 to enable the responder 106 to distribute information pertaining to incidents with varying degrees of urgency.

The methods, systems, configurations, and advantages described in FIG. 1 can be included alone or in combination in any other device or system described herein with reference to other figures. Likewise, methods, systems, configurations, and advantages described in other devices or systems with reference to other figures can be included alone or in combination shown and described with reference to FIG. 1.

FIG. 2 illustrates a diagram of dissemination of information regarding an incident, in accordance with one or more examples of the present disclosure. In some examples, the computer network system (e.g. computer network system 102 in FIG. 1) can enable the responder 206 to distribute information regarding an incident from the central storage (e.g. Central storage 110 of FIG. 1). In at least one example, responder 206, via the computer network system 102, can distribute a first information subset 218 of the dataset 216 and a second information subset 220 of the dataset 216. This can help the responder 206 to control the flow of information during an incident.

In some examples, and as illustrated in FIG. 2, the dataset 216 includes the information available to the responder 206 regarding the incident. In at least one example, the dataset 216 can include information from a variety of sources. In some examples, the information of the dataset 216 can include incident-specific information 228. In at least one example, the incident-specific information 228 can include the type of incident. For example, the type of incident can be a natural disaster, a case of bullying, or a mass shooting. In some examples, the responder 206 can be identified by the type of incident. For example, if the incident includes a situation regarding a fire, the responder 206 can be identified as the fire department. In other examples, if the incident includes a situation regarding a mass shooter, the responder 206 can be identified as the police department.

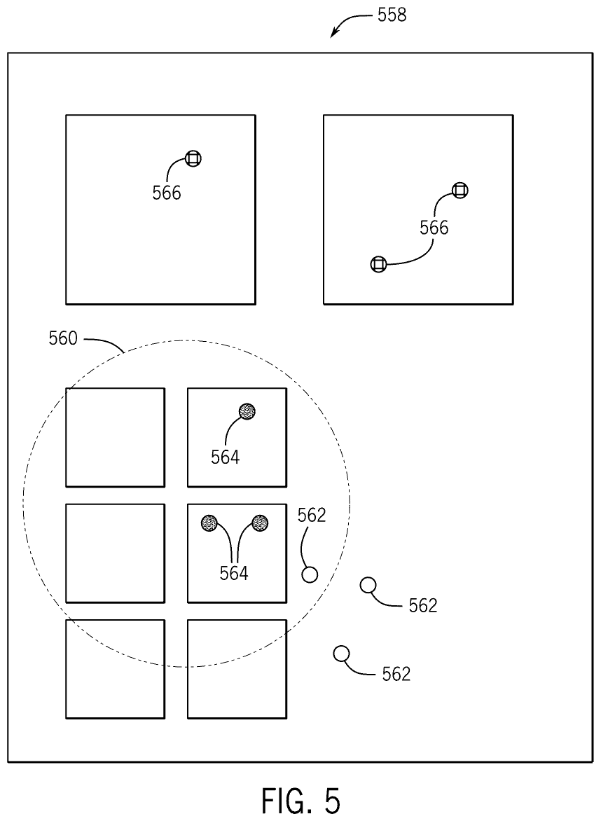

In some examples of the present disclosure, the incident-specific information 228 can include the location of the incident. Furthermore, the incident-specific information 228 can include a building structure type associated with the location of the incident. Additionally, the incident-specific information 228 can include a map overlay of the incident. An example of this map overlay is shown in FIG. 5 of the disclosure described below.

In one or more examples, the information in the dataset 216 can include tips and dispatch calls 226. In some examples, emergency phone calls can be included in the dataset 216. In additional examples, tips from witnesses or other bystanders can also be included in the dataset 216. In some examples, other alerts and notifications can be included in the dataset 216. This can provide the responder 206 with additional information regarding the incident, which can further decrease confusion between emergency personnel and reduce response times.

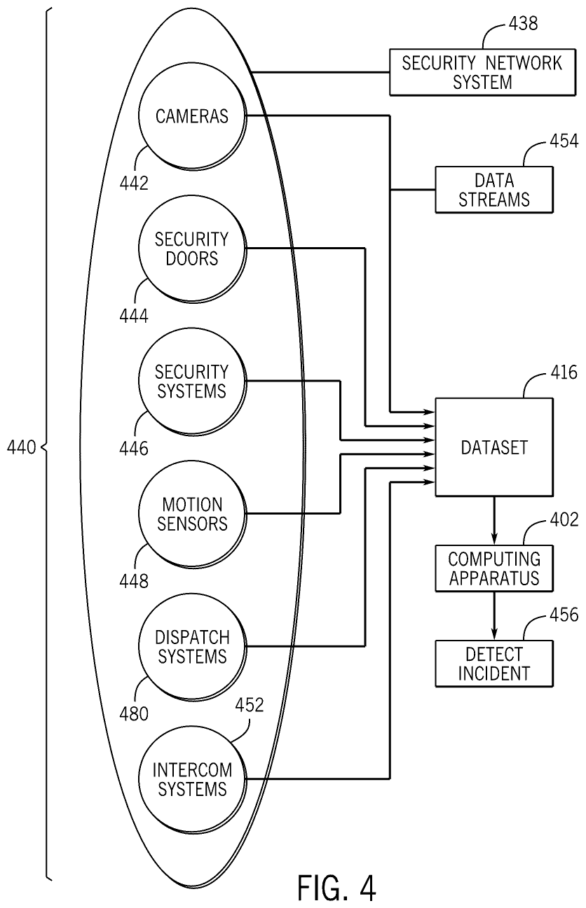

In some examples, the computer network system 102 can wirelessly connect to security networks associated with structures, organizations, or locations related to the incident. In at least one example, the computer network system 102 can receive one or more data streams 230 from these security networks. In some examples, these data streams 230 can include live camera feeds, motion sensors, and data from other components tied to security networks. More examples regarding these data streams 230 will be shown in FIG. 4. In at least one example, these data streams 230 can enable the responder 206 to attain live data of the incident, thus further increasing response capability.

In one or more examples of the present disclosure, the dataset 216 can include other data 232, where the other data 232 can be information about the incident from a variety of physical and digital sources. In some examples, the other data 232 can include social media posts, news broadcasts, articles, publications, or other information pertaining to the incident.

In some examples, the dataset 216 can also include the responder communication 217 transmitted by the responder 206 regarding the incident after the dataset 216 is received by the computer network system 102. In some examples, the responder communication 217 can include information contained in the central storage 110 of the computer network system 102. For example, the responder communication 217 can include an archived history of the instant message chat function (e.g. Instant message 108 in FIG. 1). This can enable previous communications between responders 206 and others to be available during the course of the incident. In some examples, the responder communication 217 can also include the archived history of communications between the responder 206 and the incident source (e.g. Incident source 104 in FIG. 1).

In at least one example, it can be beneficial to tailor the information received by different people and/or groups over the course of the incident. In some examples, the responder 206 can dictate what information is included in the first information subset 218 and the Second information subset 220. In some examples, the first information subset 218 and the second information subset 220 can be subsets of the dataset 216. In some examples, the first information subset 218 and the second information subset 220 can include portions of information included in the dataset 216.

In at least one example, the first information subset 218 can be sent to a first person 222. In some examples, the first person 222 can be a single individual or a group of individuals. In one or more examples, the first person 222 can be in physical proximity to the incident. For example, in the event the incident is located at a stadium, the first person 222 can be an individual located at the stadium.

Similarly, the second information subset 220 can be sent to a second person 224. In some examples, the second person 224 can be a single individual or a group of individuals. In one or more examples, the second person 224 can be physically distanced from the incident. Drawing from the example above, where the incident takes place at a stadium, the second person 224 can be an individual outside of the stadium.

In some examples of the present disclosure, the second information subset 220 can include at least a portion of the information not included in the first information subset 218. In some examples, the first information subset 218 can include information separate from the information included in the second information subset 220. In other examples, the second information subset 220 can include some information included in the first information subset 218. This can enable the responder 206 to provide relevant information to individuals with varying needs during the incident.

The methods, systems, configurations, and advantages described in FIG. 2 can be included alone or in combination in any other device or system described herein with reference to other figures. Likewise, methods, systems, configurations, and advantages described in other devices or systems with reference to other figures can be included alone or in combination shown and described with reference to FIG. 2.

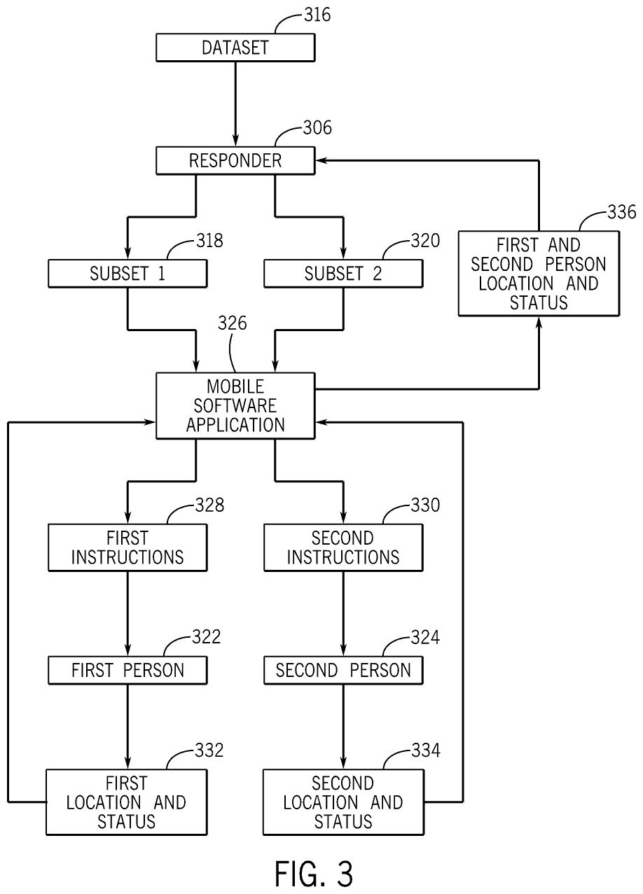

FIG. 3 illustrates a diagram of information dissemination and gathering from individuals and groups related to the incident, in accordance with one or more examples of the present disclosure. In some examples, the dataset 316 can be sent to the responder 306. After receiving the dataset 316, the responder 306 can select what information to send to different groups related to the incident. In at least one example, the responder 306 can use the information in the dataset 316 to send the first information subset 318 and the second information subset 320. In some examples, the first information subset 318 can be a first information dataset derived from the dataset 316. Similarly, the second information subset 320 can be a second information dataset derived from the dataset 316.

In some examples, the first information subset 318 can be sent to the first person 322, where the first person 322 is an individual or group of individuals in physical proximity to the incident. In one or more examples, the second information subset 320 can be sent to the second person 324, where the second person 324 is physically distanced from the incident. In at least one example, the first information subset 318 can contain at least some information not included in the second information subset 320. This can enable the responder 306 to communicate different information to individuals in physical proximity to the incident than to individuals physically removed from the incident.

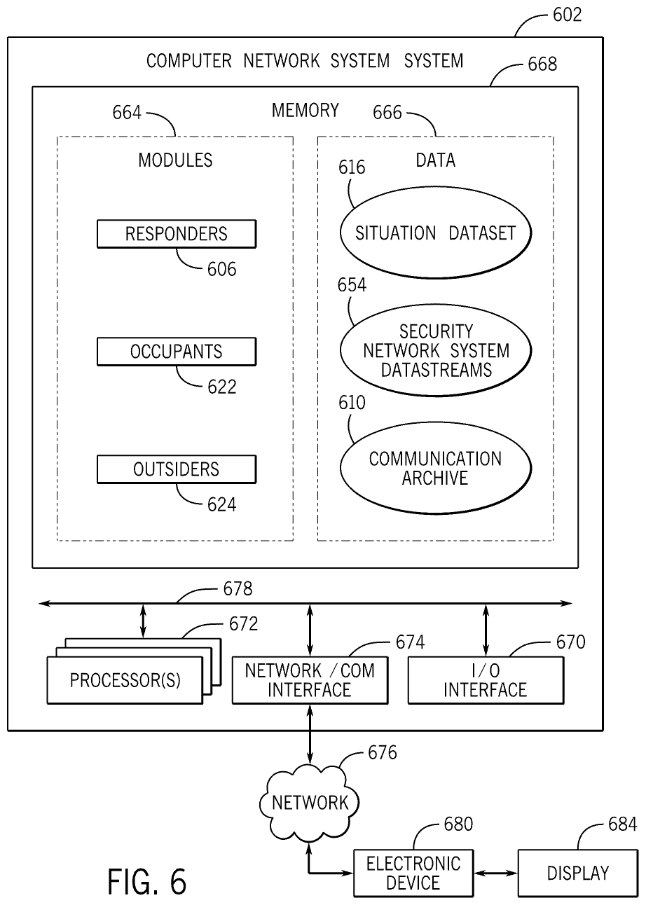

In some examples, the computer network system (e.g. Computer network system 102 in FIG. 1) can be configured to distribute the first information subset 318 and the second information subset 320 via a mobile software application 326. In some examples, the information distributed to the first person 322 and the second person 324 is viewable via the mobile software application 326. In some examples, the mobile software application 326 can be accessed from a personal device, such as a phone, tablet, or other electronic device. In this example, the information provided to the first person 322 and the second person 324 can be projected via a display of the personal device, as shown in FIG. 6 of the present disclosure.

In at least one example of the present disclosure, the first information subset 318 can include first instructions 328 from the responder 306. In some examples, the first instructions 328 can be instructions from the responder 306 regarding the incident. In one or more examples, the first instructions 328 can include an evacuation route. In this example, the mobile software application 326 can guide the first person 322 along a route designated by the responder 306. Similarly, the first instructions 328 can include a movement instruction. Depending on the type of incident, the responder 306 can desire to move the first person 322 for a variety of reasons such as safety or accessibility. In this example, the responder 306 can communicate this movement to the first person 322 via the mobile software application 326.

In additional examples, the first instructions 328 can include an incident update. In at least one example, the incident update can include the progress of the responder 306 in responding to the incident. In some examples, the responder 306 can notify the first person 322 when the incident has been responded to via the incident update.

In some examples of the present disclosure, the second information subset 320 can include second instructions 330 from the responder 306. In some examples, the second instructions 330 can be instructions from the responder 306 regarding the incident. In one or more examples, the second instructions 330 can include an alert. In some examples, the alert can notify the second person 324 that the incident has occurred. In additional examples, the second instructions 330 can include an incident update. Similar to the incident update included in the first instructions 328, the incident update can include the progress of the responder 306 in responding to the incident. In some examples, the responder 306 can notify the second person 324 when the incident has been responded to via the incident update.

In at least one example, the second instructions 330 can include location data regarding the incident. For example, the second instructions 330 can include the location of the incident. Additionally, the second instructions 330 can instruct the second person 324 to stay away from the location of the incident until the responder 306 has concluded dealing with the incident.

In some examples, the second instructions 330 can include reunification instructions. In one or more examples, the second person 324 can be connected to the first person 322. For example, the first person 322 can be a student, where the second person 324 can be a parent of the student. Following the incident, the second person 324 can desire to be reunified with the first person 322. In some examples, the responder 306 can regulate this process via the reunification process provided through the second instructions 330. In at least one example, the reunification instructions can include instructions directing the second person 324 how to reunify with the first person 322. This can decrease confusion after the incident and speed up the process in which the first person 322 and the second person 324 are reunified.

In some examples, the mobile software application 326 can be configured to obtain information from the first person 322 and the second person 324. In some examples, a first location and status 332 can be obtained by the mobile software application 326 from the first person 322. Likewise, a second location and status 334 can be obtained by the mobile software application 326 from the second person 324. In some examples, the first location and status 332 and the second location and status 334 can include location data and status data for the first person 322 and the second person 324.

In some examples, the status information obtained by the mobile software application 326 can be input by the first person 322 or the second person 324 via a personal device using the mobile software application 326. In at least one example, the status information can include health, tips, alerts, or other notification to be sent to the responder 306.

In one or more examples, the mobile software application 326 can be configured to share persons location and status data 336 to the responder. In some examples, the persons location and status data 336 can include the first location and status 332 and the second location and status 334 of the first person 322 and the second person 324, respectively. In some examples, the dataset 316 can include the persons location and status data 336. With the persons location and status data 336, the responder 306 can access data about each of the individuals in physical proximity to the incident as well as individuals with connections to the incident.

The methods, systems, configurations, and advantages described in FIG. 3 can be included alone or in combination in any other device or system described herein with reference to other figures. Likewise, methods, systems, configurations, and advantages described in other devices or systems with reference to other figures can be included alone or in combination shown and described with reference to FIG. 3.

FIG. 4 illustrates a diagram of a security network system 438, in accordance with one or more examples of the present disclosure. In some examples, the computer network system (e.g. Computer network system 102 in FIG. 1) can include a computing apparatus 402. In some examples, the computing apparatus 402 can be an electronic device with a processor and a memory that can store instructions. In some examples, the instructions can be executed by the processor to configure the computing apparatus 402 to perform the functions of the computer network system 102 described herein.

In some examples, the computing apparatus 402 can wirelessly connect to a security network system 438 located at an area of an incident. In some examples, the security network system 438 can include a combination of components 440. In at least one example, the components 440 can provide functionality and/or data to increase the security at the area of an incident. Furthermore, the computing apparatus 402 can be configured to detect the incident via information gathered by the components 440 of the security network system 438.

In one or more examples of the present disclosure, the components 440 of the security network system 438 can include a variety of different systems and devices. In at least one example, the components 440 can include one or more of a video camera 442, a motion sensor 448, and a security door 444. Additionally, the components 440 of the security network system 438 can include a security system 446. In some examples, the security system 446 can be an alarm system for the incident area. Similarly, the components 440 can include a dispatch system 450, where the dispatch system 450 can be configured to notify emergency services in the event of an incident. Furthermore, the components 440 can include an intercom system 452 located at the incident area. In some examples, the components 440 of the security network system 438 can include other systems or devices.

In some examples, the components 440 of the security network system 438 can be configured to gather information from the incident area. For example, the video camera 442 can obtain video data of the incident area. In another example, the security door 444 can obtain data on what doors are open in the incident area. In one or more examples, the information gathered from the components 440 of the security network system 438 can be dynamically updated via a data stream 454 to the processor of the computing apparatus 402. In some examples, each of the components 440 can include a data stream 454 to the processor of the computing apparatus 402.

In some examples, the data stream 454 from each of the components 440 can be included in the dataset 416. In some examples, the computing apparatus 402 can be configured to detect the incident from the information streamed to the dataset 416 via a detect incident function 456. In one or more examples, the instructions to the processor of the computing apparatus 402 for the detect incident function 456 can include a facial recognition algorithm. In some examples, the processor can be configured to detect the incident via the facial recognition algorithm using algorithm inputs including the information from the components 440 of the security network system 438. For example, the detect incident function 456 can use the facial recognition algorithm to detect criminals and other suspects through the use of the video camera 442.

Similarly, the instructions to the processor of the computing apparatus 402 for the detect incident function 456 can include an object recognition algorithm. In some examples, the processor of the components 440 can be configured to detect the incident via the object recognition algorithm using algorithm inputs including the information from the components 440 of the security network system 438. For example, the detect incident function 456 can use the object recognition algorithm to detect guns, bombs, or other kinds of weapons from the data streams 230 of the components 440 of the security network system 438.

The methods, systems, configurations, and advantages described in FIG. 4 can be included alone or in combination in any other device or system described herein with reference to other figures. Likewise, methods, systems, configurations, and advantages described in other devices or systems with reference to other figures can be included alone or in combination shown and described with reference to FIG. 4.

FIG. 5. Illustrates an example of an incident area map 558, in accordance with one or more examples of the present disclosure. In some examples, the computing apparatus (e.g. Computing apparatus 402 in FIG. 4) can be configured to overlay information regarding the incident onto the incident area map 558. As shown in FIG. 5, the different blocks can represent buildings or rooms surrounding the incident. In some examples, the computing apparatus 402 can overlay the persons location and status data (e.g. Persons location and status data 336 in FIG. 3) onto the incident area map 558. This can enable the responder 106 (e.g. Responder 106 in FIG. 1) to know what individuals are in and around the incident area. This can help the responder 106 effectively respond to a wide variety of incidents.

In some examples, the incident area map 558 can include an incident radius 560. In some examples, the incident radius 560 can be defined as the epicenter of the incident. In some examples, individuals located within the incident radius 560 can be categorized as the first person(s) (e.g. First person 322 in FIG. 3). Similarly, the individuals located outside of the incident radius 560 can be categorized as the second person(s) (e.g. (second person 324 in FIG. 3). In some examples, the responders 106 can also be portrayed on the incident area map 558.

In some examples, the first person 322 can be portrayed on the incident area map 558 by a first person dot 564. As shown in FIG. 5, the first person dot(s) 564 can be the black dots disposed within the incident radius 560. In one or more examples, the second person 324 can be portrayed on the incident area map 558 by a second person dot 566. In some examples, the second person dot 566 can be the patterned dots disposed outside of the incident radius 560. Additionally, the responder 106 can be portrayed on the incident area map 558 by a responder dot 562. In some examples, the responder dot 562 can be the white dots disposed inside and outside of the incident radius 560. In at least some examples, the responder 106 can use the incident area map 558 to locate the first person(s) 322 and the second person(s) 324 during the incident.

In some examples, the incident area map 558 can be configured to be projected by a display of an electronic device shown in FIG. 6. In one or more examples, the electronic device can be a personal device such as a phone, tablet, or other computing device.

The methods, systems, configurations, and advantages described in FIG. 5 can be included alone or in combination in any other device or system described herein with reference to other figures. Likewise, methods, systems, configurations, and advantages described in other devices or systems with reference to other figures can be included alone or in combination shown and described with reference to FIG. 5.

FIG. 6 is a block diagram of a computer network system 602 for gathering and disseminating incident information, in accordance with one or more embodiments of the present disclosure. The computer network system 602 can perform the method of the signal flow block diagram in FIG. 6. The computer network system 602 can include a memory 668, one or more processor(s) 672, a network/COM interface 674, an input/output I/O interface 670, and a system bus 678.

In some examples, the processor(s) 672 can include one or more general purpose devices, such as an Intel®, AMD®, or other standard microprocessor. The one or more processors 672 can include a special purpose processing device, such as ASIC, SoC, SiP, FPGA, PAL, PLA, FPLA, PLD, or other customized or programmable device. The one or more processors 672 can perform distributed (e.g., parallel) processing to execute or otherwise implement functionalities of the presently disclosed embodiments. The processor(s) 672 can run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

In one or more examples, the memory 668 can include static RAM, dynamic RAM, flash memory, one or more flip-flops, ROM, CD-ROM, DVD, disk, tape, or magnetic, optical, or other computer storage medium. The memory 668 can include a plurality of program modules 604 and program data 666. The memory 608 can be local to the computer network system 602, as shown, or can be distributed and/or remote relative to the computer network system 602.

In at least one example, the program modules 604 can include all or portions of other elements of the computer network system 602. The program modules 604 can run multiple operations concurrently or in parallel by or on the processor(s) 672. In some embodiments, portions of the disclosed modules, components, and/or facilities are embodied as executable instructions embodied in hardware or in firmware, or stored on a non-transitory, machine-readable storage medium. The instructions can comprise computer program code that, when executed by a processor and/or computing apparatus, cause a computing system to implement certain processing steps, procedures, and/or operations, as disclosed herein. The modules, components, and/or facilities disclosed herein can be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

In some examples, the modules 604 can include a responder group 606, an occupant group 622, and an outsider group 624. In some examples, the responder group 606 can include functions pertaining to the responder (e.g. Responder 106 in FIG. 1). The occupant group 622 can include functions pertaining to the first person (e.g. First person 322 in FIG. 3), and the outsider group 624 can include functions pertaining to the second person (e.g. Second person 324 in FIG. 3).

In some examples, the memory 608 can also include the data 666. Data generated by the computer network system 602 can be stored on the memory 608. The data 666 can include a Situation dataset 616, a security network system data streams 654, and a communication archive 610.

In at least one example, the I/O interface 670 can facilitate user interaction with one or more input devices and/or one or more output devices. The input device(s) can include a keyboard, mouse, display 684, light pen, tablet, microphone, sensor, or other hardware with accompanying firmware and/or software. In some examples, the display 684 can be configured to project the data 666, I/O interface 670, maps, and other information included in the computer network system 602. The output device(s) may include a monitor or other display, printer, speech or text synthesizer, switch, signal line, or other hardware with accompanying firmware and/or software.

In some examples, a network 676 can facilitate communication with other computing devices and/or networks and/or other computing and/or communications networks. For example, the network 676 can communicate with an electronic device 680. In some examples, the computer network system 602 can provide the electronic device 680 with a graphical user interface to receive inputs and display outputs.

In one or more examples. The network 676 can be equipped with conventional network connectivity, such as, for example, Ethernet (IEEE 1102.3), Token Ring (IEEE 1102.5), Fiber Distributed Datalink Interface (FDDI), or Asynchronous Transfer Mode (ATM). Further, the network 676 can be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

In some examples, the system bus 678 can facilitate communication and/or interaction between the other components of the computer network system system 602, including the processor(s) 672, the memory 608, the I/O interface 670, and the network/COM interface 674.

The methods, systems, configurations, and advantages described in FIG. 6 can be included alone or in combination in any other device or system described herein with reference to other figures. Likewise, methods, systems, configurations, and advantages described in other devices or systems with reference to other figures can be included alone or in combination shown and described with reference to FIG. 6.

The following non-limiting examples of implementations of the devices, systems, and method described herein are not intended to limit the scope of the present disclosure. Rather, the following examples are described in order to provide useful context and understanding of the devices, systems, and methods described herein:

### Example 1

In one example, a shooting takes place at a school. In this example, the shooter enters the school and the police receive numerous 911 calls alerting them of the emergency situation. In accordance with the present disclosure, all the 911 calls can be recorded in the central storage of the computer network system. The interactions between the dispatcher and the witnesses can then be made available to the officers responding to the call. In this example, each of the officers can get caught up to speed via the network system.

As the police officers commute to the school, they can be provided with the dataset containing incident-specific information. In this example, the officers can receive a layout of the building before they walk in. Additionally, the teachers inside the school can use the mobile software application to share their location and status with the officers. Over the course of the incident, the teachers can send additional information pertinent to the resolution of the incident. As the officers clear the school, they can view a map overlay of the school and the locations and statuses of the individuals within the incident radius.

Over the course of the incident, the officers can send notifications to both the people inside the incident radius and those waiting at the perimeter of the incident of their progress. The officers can also send instructions to specific teachers telling them to move, how to evacuate, or if they need to hunker down. The officers can also notify the media of new developments via the computer network system. Once the incident has ended and the situation is no longer an emergency, the officers can send reunification instructions to the parents of the students via the mobile software application.

### Example 2

In another example, a bomb threat is made at a football stadium. In this example, the computing apparatus can be wirelessly connected to the security network of the stadium. The computing apparatus can use object detection to detect an object that could be a bomb. The incident-specific information of the dataset is updated to include a potential bomb threat. In this example, a bomb squad is notified as per the change in the type of incident occurring.

### Example 3

In a third example, a fire breaks out in an office building. In this example, the computing apparatus can be wirelessly connected to the smoke alarms in the office building. Once the fire starts, the fire department is notified and a truck is dispatched to take care of the fire. On the way there, the firemen are provided a structural layout of the building, along with a map overlay of the different people in the building. In this manner, the firemen can plan how to respond to the fire before arriving at the incident area. Over the course of the incident, the firemen can send evacuation routes to the people inside the building. Those who are struggling to evacuate can be tracked via the map overlay and rescued by the firemen.

### Example 4

In another example, a student is seen being bullied at an elementary school. A teacher can submit a report, which is added to the dataset regarding the incident information. The dataset can be sent to the school administration, where the school administration can select where and to whom to distribute information regarding the bullying. In this example, the administration can choose to notify the parents by sending instruction to the mobile software application. The school can also choose to notify the bullied student's teacher and the parents of the bully with different sets of information derived from the initial dataset.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A computer network system for gathering and disseminating information regarding an incident, the system comprising a processor electrically coupled to a memory component storing executable instructions that, when executed by the processor, cause the system to:
receive a dataset including the information regarding the incident at a central storage;
enable a responder to the incident to distribute the information from the central storage, including distributing a first information subset of the dataset and distributing a second information subset of the dataset selected by the responder;
send the first information subset to a first person in physical proximity to the incident; and
send the second information subset of the dataset to a second person physically distanced from the incident,
wherein:
the second information subset includes at least a portion of the information not included in the first information subset; and
the dataset includes a communication transmitted by the responder regarding the incident after the dataset is received.

2. The system of claim 1, wherein:
the responder is a first responder; and
the transmitted communication includes a communication from the first responder to a second responder to the incident.

3. The system of claim 2, wherein system further enables the first and second responders to participate in inter-group communications via an instant message chat function.

4. The system of claim 1, wherein the information comprises at least one of a type of the incident, a location of the incident, a building structure type associated with the incident, or a map overlay of the incident.

5. The system of claim 4, wherein the responder is identified based on at least the type of the incident.

6. The system of claim 1, wherein the system is configured to distribute the first information dataset and the second information dataset via a mobile software application.

7. The system of claim 6, wherein:
the dataset includes status and locational information of the first person and the second person; and
the mobile software application is configured to share the status and locational information to the responder.

8. The system of claim 1, wherein the first information subset includes instructions from the responder comprising at least one of an evacuation route, a movement instruction, or an incident update.

9. The system of claim 1, wherein the second information subset includes instructions from the responder comprising at least one of an alert, an incident update, location data, or reunification instructions.

10. The system of claim 9, wherein the reunification instructions include directing the second person how to reunify with the first person.

11. A computing apparatus comprising:
a processor; and
a memory storing instructions that, when executed by the processor, configure the apparatus to:
wirelessly connect to a security network system located at an area of an incident;
detect the incident via information gathered by components of the security network system;
receive a dataset from the security network system, the dataset including the gathered information regarding the incident;
enable an incident responder to distribute the information from the dataset, wherein the information includes a first subset of the dataset selected by the responder and a second subset of the dataset;
send the first subset to a first group of persons located at the area; and
send the second subset to a second group of persons physically distanced from the area,
wherein the first subset includes at least a portion of the information not included in the second subset.

12. The computing apparatus of claim 11, wherein the components of the security network system include at least one of a video camera, a security door, a security system, a motion sensor, a first responder dispatch system, or an intercom system.

13. The computing apparatus of claim 11, wherein the information is dynamically updated via a data stream to the processor.

14. The computing apparatus of claim 13, wherein:
the computing apparatus further comprises a display electrically coupled to the processor; and
the processor is configured to overlay at least a portion of the information onto a map of the area projected by the display.

15. The computing apparatus of claim 11, wherein:
the instructions include a facial recognition algorithm; and
the processor is configured to detect the incident via the facial recognition algorithm using algorithm inputs including the information from the components of the security network system.

16. The computing apparatus of claim 11, wherein:
the instructions include an object recognition algorithm; and
the processor is configured to detect the incident via the object recognition algorithm using algorithm inputs including the information from the components of the security network system.

17. The computing apparatus of claim 11, wherein the information distributed to first group of persons and the second group of persons is viewable via a mobile software application.

18. A non-transitory computer-readable storage medium, the computer-readable storage medium including instructions that, when executed by a computer, cause the computer to:
receive a report from a witness of an incident;
notify a responder of the report;
enable the responder to distribute information from the report, wherein the information includes a portion of the report selected by the responder;
send the portion of the report to an incident group, the incident group comprising an individual who did not witness the incident.

19. The non-transitory computer-readable storage medium of claim 18, wherein the responder includes an individual having authority over a premises of the incident.

20. The non-transitory computer-readable storage medium of claim 18, wherein the report comprises at least one of an alert, a notification, or a tip corresponding to the incident.
